(19) United States
(12) Patent Application Publication
(10) Pub. No.: US 2025/0359518 A1
(43) Pub. Date: Nov. 27, 2025

(54) PROTECTIVE PLANT BARRIER AND SOIL ENHANCER

(71) Applicant: Three Little Frogs, LLC, North Charleston, SC (US)

(72) Inventor: Katheryn Beth Roberts, North Charleston, SC (US)

(73) Assignee: Three Little Frogs, LLC, North Charleston, SC (US)

(21) Appl. No.: 19/214,173

(22) Filed: May 21, 2025

Related U.S. Application Data
(60) Provisional application No. 63/650,024, filed on May 21, 2024.

(51) Int. Cl. A01G 13/10; A01G 13/30; A01G 24/15; A01G 24/22; A01G 24/28; A01M 29/12

(52) U.S. Cl. CPC A01G 13/10; A01G 13/30; A01G 24/15; A01G 24/22; A01G 24/28; A01M 29/12

(57) ABSTRACT

Described herein are a protective plant barrier and soil enhancer, and methods for making same, that surrounds and protects seeds, seedlings, and growing/grown plants from insect pests while also providing enhancements to the soil to improve plant growth.

### TECHNICAL FIELD

The subject matter disclosed herein is generally directed to a protective plant barrier and soil enhancer, and methods for making same, that surrounds and protects seeds, seedlings, and growing/grown plants from insect pests while also providing enhancements to the soil to improve plant growth.

### BACKGROUND

The majority of small invertebrate animals belong to Phylum Arthropoda, which consists of organisms with external skeletons and jointed legs. Insects, Class Hexapoda (meaning “six-footed”), have the largest number of species within this phylum. In addition to the characteristics already mentioned, insects also are distinguished by having one pair of antennae, and most have wings and three body regions as adults. Centipedes, millipedes, mites, sow bugs, and spiders are non-insect arthropods: all have external skeletons, but adults have more than six legs. Insects are by far the most abundant animals in the world, both in numbers of species and individuals. Fossil remains show that insects inhabited the world long before other animals now living appeared.

Most insects obtain their food from plants. Bees live on nectar and pollen from flowers. The larvae of many beetles, moths, butterflies, and flies live in or on plants. Many bugs suck the sap or cell contents from plants as a source of food. Insects may feed on leaves, stems, roots, and flowers of plants. The chewing insects actually consume the infested parts. Types of leaf feeding by chewing insects include pit feeding on leaves by leaf beetles, flea beetles, and young caterpillars. Irregular notches along the edges of leaves are typically caused by various weevils, larger caterpillars, grasshoppers and katydids. Perfect semicircular cut portions of leaves indicate the presence of leaf cutter bees. Feeding entirely within leaves is called mining. Leaf miners can be found among beetles, flies, sawflies, and moths.

Stem chewing typically is done by borers, which feed internally as larvae. Important borers include long horned beetles (round headed borers), metallic wood boring beetles (flat headed borers), engraver beetles, clearwing moths, American plum borer (a moth), and a few less commonly encountered moths.

Root chewing insects include species that subsist entirely on plant tissue for development, such as root weevils and root maggots, and those that feed on a combination of soil organic matter and roots (most white grubs).

Sucking insects remove cell contents (e.g., thrips) or sap (e.g., aphids, leafhoppers, scales, etc. . . . ) and thereby weaken the plants. Some of these sucking insects inject salivary fluids into plants. This secretion may: (1) kill plants, as evidenced by armored scale feeding; (2) cause galls to form, as in the case of gall aphids; or (3) kill portions of a leaf, as seen in leafhopper “burn.” Sucking insects tend to ingest more water and sugars than amino acids. Sucking insects balance their nutrition by excreting the excess sugar-water as honeydew, which is objectionably sticky and supports the growth of sooty mold. Honeydew can also lure nuisance stinging wasps, and also attracts ants, which protect the sucking aphids from predators and parasites.

Insertion of sucking mouthparts into plants increases potential for the transmission of plant disease organisms. Sucking insects, such as leafhoppers moving among plants can transmit mycoplasma-like organisms that cause Peach X-disease and aster yellows. Aphids and leafhoppers transmit viruses to plants. Preventing the transmission of viruses can be the chief reason to control certain insects. An example is the importance of controlling western flower thrips when growing impatiens. Their transmission of tomato spotted wilt virus can devastate a crop being started in a greenhouse.

Some insects cause damage by cutting the plants for egg-laying. Conspicuous among these are cicadas, which during years of peak emergence can cause considerable damage to small branches of trees. Tree crickets also lay eggs in stems, and while doing so, may transmit disease agents.

Prior attempts exist. For example, AU637493, Whitford, shows a plant protection ring 10 is formed to a part-conical shape, but is open ended. It is buried in the top soil 11 for about half its depth, the other half of the depth surrounds the leaves of a seedling 12. Illustrated is a typical rain shower designated 13 which will impinge against side walls of the protection ring, and also enter the space surrounded by the ring through the mouth of the ring. The significance of the ring is that it is made from water absorbing material as described below and the moisture is conducted by the ring downwardly into the soil below the surface, the material of the formation functioning as a “wick”. See ¶¶1-3.

U.S. Pat. No. 8,434,260, Stuart, provides a decorative surround for potted plants. The surround may be a shell having a generally convex outer surface and an aperture in the shell suitable for either receiving or supporting a plant pot. The surround may be supported with respect to the ground or other reference surface by the periphery of the shell or by the bottom of a structure within the aperture, and the surround held against the ground by the weight of the potted plant. Alternatively, the surround may be affixed to the ground with pins or stakes. Another decorative surround is sized so that the aperture is smaller than a maximum diameter of the plant pot, and a strap is provided to hold the plant pot against an inner surface of the shell. The visible surface of the surround may be formed, textured or colored so as to have a visual appearance simulating natural rock. (Abstract.)

U.S. 2010/90387694, Pagnoncelli et al., provides a modular apparatus for protecting a plant from invasive species and adapting a protective area as a plant grows with little to no post-planting maintenance. For example, a modular apparatus comprises a base comprising a first rim, a water storage, and a plug-in-joint, a lid comprising a second rim and an opening, wherein the first rim is configured to correspondingly fit the second rim, wherein the opening is configured to correspondingly fit the plug-in joint; and a recess disposed on an edge of the base and on an edge of the lid. An infinite number of modular apparatuses can be coupled to expand protection for plant growth. The modular plant protecting apparatus can be installed manually or deployed by an aerial vehicle into degraded areas with limited-access. (Abstract.)

WO 2011/027036, Joenkkaeri et al., provides a plant protection is intended for protecting a plant against competing vegetation and/or vermin. The plant protection (1) comprises at least biodegradable plastic and bone meal in a mixture. Animal fiber, such as animal or human hairs, can be used as reinforcement. FIG. 1 shows an example of a seedling 2 with a seedling protection 1, in a side view. The seedling protection 1 is a disc-like or plate-like piece covering an area of a given size around the seedling 2, which piece may be a single piece or composed of two or more parts. In the center of the seedling protection 1, an opening 4 is provided for the stem of the seedling 2, and if the seedling protection 1 is made of a single uniform piece, it also has a slit 5 extending from the outer circumference 9 to the inner circumference 10 of the seedling protection 1 (shown in FIGS. 3a-b), through which slit the protection can be introduced around the seedling. FIG. 1 shows, among other things, the seedling protection 1, the seedling 2, the opening 4 for the stem of the seedling, inclinations 6, the outer circumference 9 of the seedling protection, and the inner circumference 10 of the seedling protection. See, p. 7, 1. 18-p. 9, 1. 3.

U.S. Pat. No. 4,133,141, Lee, discloses a tank provided with a nutrient supply, a separate water supply and a body of particulate support medium for the plant roots. A valve is provided for controlling access to the nutrient supply. The plant roots also may grow into the water supply for obtaining water separately from nutrients. In one version, the plants grow at the center of the tank, surrounded by the nutrient supply; in another version the nutrient supply is at the center and the plants grow in a ring around it. Versions for use on land and floating on bodies of water are disclosed. (Abstract.)

With insects presenting a plethora of potential problems for growing and grown plants, protecting plants is a major concern for gardeners and farmers. Accordingly, it is an object of the present disclosure to provide a protective plant barrier and soil enhancer to help fend off intrusive insects as well as to help nourish the soil providing sustenance to the plant.

Citation or identification of any document in this application is not an admission that such a document is available as prior art to the present disclosure.

### SUMMARY

The above objectives are accomplished according to the present disclosure by providing a combination plant barrier and soil enhancer. The combination plant barrier and soil enhancer may include a plant barrier comprising a shaped enhancer body, at least one shaped internal opening, at least one insect repellent, at least one soil conditioner, at least one continuous sloped wall formed as an outer surface of the enhancer body; and at least one continuous interior sloped wall formed as an inner surface of the enhancer body. Further, the shaped enhancer body may be formed in a shape of a ring defining at least one shaped internal opening. Still, the at least one shaped internal opening may be defined as a substantially circular opening. Moreover, the shaped enhancer body may comprise a diameter of from 6 to 10 inches. Further yet, the shaped enhancer body may comprise a width from 0.25 to 2.0 inches. Furthermore, the shaped enhancer body may comprise Portland cement, diatomaceous earth, peat moss, earthworm castings, black pepper, coffee grounds, and bone meal. Further again, the shaped enhancer body may comprise Diatomaceous earth from 5 to 15 percent by weight, peat moss by 5 to 15 percent by weight, and vermiculite from 5 to 15% by weight. Yet still, the shaped enhancer body may comprise at least one pepper extract, blood meal, Epsom salt, at least one allium extract, at least one rosemary extract, tansy extract, neem oil, peppermint oil, vinegar tea and worm tea. Again further, the shaped enhancer body may define at least one continuous interior sloped wall formed as an outer surface of the enhancer body. Still yet further, the at least one continuous sloped wall and the at least one continuous inner wall may define different slopes with respect to one another.

The objectives are further accomplished by providing a method for making a combination plant barrier and soil enhancer. The method may include forming a plant barrier comprising a shaped enhancer body, configuring the shaped enhancer body to define at least one shaped internal opening, configuring the shaped enhancer body to contain at least one insect repellent, configuring the shaped enhancer body to contain at least one soil conditioner, configuring the shaped enhancer body to define at least one continuous sloped wall formed as an outer surface of the enhancer body; and the shaped enhancer body may define at least one continuous interior sloped wall formed as an inner surface of the enhancer body. Further, the shaped enhancer body may be in the shape of a ring defining at least one shaped internal opening. Again, the at least one shaped internal opening may be a substantially circular opening. Still further, the shaped enhancer body may be configured with a diameter of from 6 to 10 inches. Moreover, the shaped enhancer body may be configured with a width from 0.25 to 2.0 inches. Still again, the shaped enhancer body may comprise Portland cement, diatomaceous earth, peat moss, earthworm castings, black pepper, coffee grounds, and bone meal. Still yet further, the shaped enhancer body may comprise Diatomaceous earth from 5 to 15 percent by weight, peat moss by 5 to 15 percent by weight, and vermiculite from 5 to 15% by weight. Still yet again, the shaped enhancer body may comprise at least one pepper extract, blood meal, Epsom salt, at least one allium extract, at least one rosemary extract, tansy extract, neem oil, peppermint oil, vinegar tea and worm tea. Furthermore, the shaped enhancer body may define at least one continuous interior sloped wall formed as an outer surface of the enhancer body. Yet again further, the at least one continuous sloped wall and the at least one continuous inner wall may define different slopes with respect to one another.

These and other aspects, objects, features, and advantages of the example embodiments will become apparent to those having ordinary skill in the art upon consideration of the following detailed description of example embodiments.

### BRIEF DESCRIPTION OF THE DRAWINGS

An understanding of the features and advantages of the present disclosure will be obtained by reference to the following detailed description that sets forth illustrative embodiments, in which the principles of the disclosure may be utilized, and the accompanying drawings of which:

FIG. 1 shows a seedling in a protective plant barrier and soil enhancer of the current disclosure.

FIG. 2 shows a seedling at 4 weeks growth, growing in a protective plant barrier and soil enhancer of the current disclosure.

FIG. 3 shows a seedling at 5 weeks growth, growing in a protective plant barrier and soil enhancer of the current disclosure.

FIG. 4 shows a seedling at 6 weeks growth, growing in a protective plant barrier and soil enhancer of the current disclosure.

The figures herein are for illustrative purposes only and are not necessarily drawn to scale.

### DETAILED DESCRIPTION OF THE EXAMPLE EMBODIMENTS

Before the present disclosure is described in greater detail, it is to be understood that this disclosure is not limited to particular embodiments described, and as such may, of course, vary. It is also to be understood that the terminology used herein is for the purpose of describing particular embodiments only and is not intended to be limiting.

Unless specifically stated, terms and phrases used in this document, and variations thereof, unless otherwise expressly stated, should be construed as open ended as opposed to limiting. Likewise, a group of items linked with the conjunction “and” should not be read as requiring that each and every one of those items be present in the grouping but rather should be read as “and/or” unless expressly stated otherwise. Similarly, a group of items linked with the conjunction “or” should not be read as requiring mutual exclusivity among that group but rather should also be read as “and/or” unless expressly stated otherwise.

Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are cited to disclose and describe the methods and/or materials in connection with which the publications are cited. All such publications and patents are herein incorporated by references as if each individual publication or patent were specifically and individually indicated to be incorporated by reference. Such incorporation by reference is expressly limited to the methods and/or materials described in the cited publications and patents and does not extend to any lexicographical definitions from the cited publications and patents. Any lexicographical definition in the publications and patents cited that is not also expressly repeated in the instant application should not be treated as such and should not be read as defining any terms appearing in the accompanying claims. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Where a range is expressed, a further embodiment includes from the one particular value and/or to the other particular value. The recitation of numerical ranges by endpoints includes all numbers and fractions subsumed within the respective ranges, as well as the recited endpoints. Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure. For example, where the stated range includes one or both of the limits, ranges excluding either or both of those included limits are also included in the disclosure, e.g., the phrase “x to y” includes the range from ‘x’ to ‘y’ as well as the range greater than ‘x’ and less than ‘y’. The range can also be expressed as an upper limit, e.g., ‘about x, y, z, or less’ and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In addition, the phrase “about ‘x’ to ‘y’”, where ‘x’ and ‘y’ are numerical values, includes “about ‘x’ to about ‘y’”.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the singular forms “a” “an”, and “the” include both singular and plural referents unless the context clearly dictates otherwise.

As used herein, “about,” “approximately,” “substantially,” and the like, when used in connection with a measurable variable such as a parameter, an amount, a temporal duration, and the like, are meant to encompass variations of and from the specified value including those within experimental error (which can be determined by e.g., given data set, art accepted standard, and/or with e.g., a given confidence interval (e.g., 90%, 95%, or more confidence interval from the mean), such as variations of +/−10% or less, +1-5% or less, +/−1% or less, and +/−0.1% or less of and from the specified value, insofar such variations are appropriate to perform in the disclosure. As used herein, the terms “about,” “approximate,” “at or about,” and “substantially” can mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

The term “optional” or “optionally” means that the subsequent described event, circumstance or substituent may or may not occur, and that the description includes instances where the event or circumstance occurs and instances where it does not.

As used interchangeably herein, the terms “sufficient” and “effective,” can refer to an amount (e.g., mass, volume, dosage, concentration, and/or time period) needed to achieve one or more desired and/or stated result(s). For example, a therapeutically effective amount refers to an amount needed to achieve one or more therapeutic effects.

As used herein, “tangible medium of expression” refers to a medium that is physically tangible or accessible and is not a mere abstract thought or an unrecorded spoken word. “Tangible medium of expression” includes, but is not limited to, words on a cellulosic or plastic material, or data stored in a suitable computer readable memory form. The data can be stored on a unit device, such as a flash memory or CD-ROM or on a server that can be accessed by a user via, e.g., a web interface.

As used herein, the terms “weight percent,” “wt %,” and “wt. %,” which can be used interchangeably, indicate the percent by weight of a given component based on the total weight of a composition of which it is a component, unless otherwise specified. That is, unless otherwise specified, all wt % values are based on the total weight of the composition. It should be understood that the sum of wt % values for all components in a disclosed composition or formulation are equal to 100. Alternatively, if the wt % value is based on the total weight of a subset of components in a composition, it should be understood that the sum of wt % values the specified components in the disclosed composition or formulation are equal to 100.

As used herein, “water-soluble”, generally means at least about 10 g of a substance is soluble in 1 L of water, i.e., at neutral pH, at 25° C.

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s). Reference throughout this specification to “one embodiment”, “an embodiment,” “an example embodiment,” means that a particular feature, structure or characteristic described in connection with the embodiment is included in at least one embodiment of the present disclosure. Thus, appearances of the phrases “in one embodiment,” “in an embodiment,” or “an example embodiment” in various places throughout this specification are not necessarily all referring to the same embodiment but may. Furthermore, the particular features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the disclosure. For example, in the appended claims, any of the claimed embodiments can be used in any combination.

All patents, patent applications, published applications, and publications, databases, websites and other published materials cited herein are hereby incorporated by reference to the same extent as though each individual publication, published patent document, or patent application was specifically and individually indicated as being incorporated by reference.

### Kits

Any of the protective plant barriers and soil enhancers described herein can be presented as a combination kit. As used herein, the terms “combination kit” or “kit of parts” refers to the compounds, compositions, formulations, barriers, and any additional components that are used to package, sell, market, deliver, and/or administer the combination of elements or a single element, such as the protective plant barriers and soil enhancers contained therein. Such additional components include, but are not limited to, packaging, blister packages, wrapping, and the like. When one or more of the compounds, compositions, formulations, barriers, and any additional components described herein or a combination thereof (e.g., a plant barrier and soil enhancer with accompanying agents contained in the kit are provided simultaneously, the combination kit can contain the plant barrier and soil enhancer in a single formulation, such as a single piece unit or in separate combinations, such as a plant barrier and soil enhancer accompanied by insect repellents, fertilizing materials, plant growth media, etc., that may be added to or used in conjunction with the plant barrier and soil enhancer. When the compounds, compositions, formulations, barriers, and any additional components described herein or a combination thereof and/or kit components are not provided simultaneously, the combination kit can contain each agent or other component in separate embodiments. The separate kit components can be contained in a single package or in separate packages within the kit.

In some embodiments, the combination kit also includes instructions printed on or otherwise contained in a tangible medium of expression. The instructions can provide information regarding the content of the compounds and/or formulations, safety information regarding the content of the compounds and formulations, information regarding the dosages, indications for use, and/or recommended treatment regimen(s) for the plant barrier and soil enhancer contained therein. In some embodiments, the instructions can provide directions and protocols for administering the compounds and/or formulations described herein to a plant, seedling, or seed. In some embodiments, the instructions can provide one or more embodiments of the methods for using the plant barrier and soil enhancer such as any of the methods described in greater detail elsewhere herein.

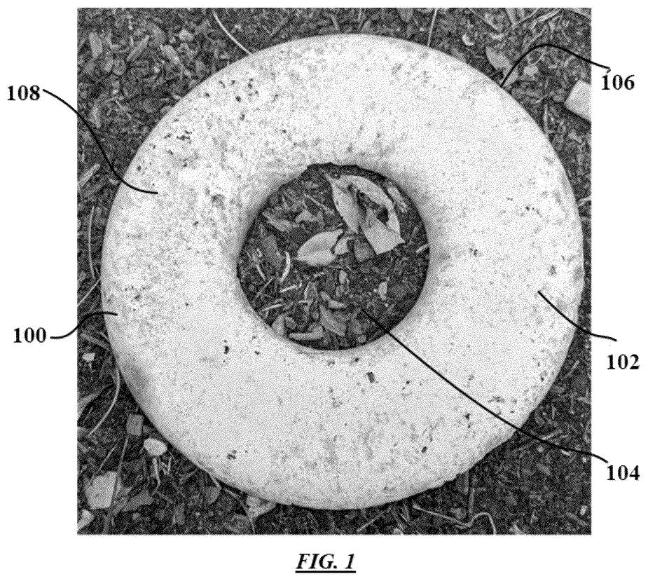

The current disclosure provides a protective plant barrier and soil enhancer. FIG. 1 shows one embodiment of the protective plant barrier and soil enhancer 100. Enhancer 100 may be configured in a wide variety of shapes and sizes. While shown as a circular ring in FIG. 1, the current disclosure is not so limited and any shape or size of enhancer body 102 and enhancer opening 104 are considered within the scope of this disclosure and herein disclosed. Indeed, enhancer 100 may define multiple enhancer openings 104 positioned throughout enhancer body 108. Enhancer body outer edge 106 may be polygonal, oval, irregular shaped, etc., indeed, multiple enhancer bodies 102 may be configured as puzzle pieces to fit together over a large surface area for both aesthetic appeal as well as providing insect repellant/soil enhancement properties to multiple plants in an area. Enhancer opening 104 may be shaped similarly to enhancer body 102 or may differ in shape, such as being circular in shape when enhancer body 102 is polygonal, etc.

Enhancer body 102 diameter dimensions may range from 6 to 10 inches, with a depth or width of enhance body 102 ranging from 0.25 to 2.0 inches. These measurements help ensure enhancer 100 provides an appropriate physical barrier to block pests from any plant withing enhancer 100. Too narrow or too thin of an enhancer would not serve to deter insects or pests as they could quickly traverse enhancer 100 if too narrow or thin, whereas a thicker barrier increases deterrent effect of enhancer 100. In one embodiment, enhancer body 102 diameter dimensions may be 6 inches. In one embodiment, enhancer body 102 diameter dimensions may be 8 inches. In one embodiment, enhancer body 102 diameter dimensions may be 10 inches. Both larger and custom sizes may also be provided. Further, enhancer body 102 may be configured to contain a wide variety of insect repellant/soil conditioner materials. This may include: earthworm castings, which acts as organic fertilizer that improves the structure of the soil, increases water retention, improves aeration, anchors nutrients and repels an array of insects; bone meal, which has high levels of phosphorus, calcium and is an organic product that breaks down slowly, promotes strength and plant growth and decomposes naturally; black pepper, which repels most insects, does not harm plants, is fatal to ants and antibacterial; coffee grounds, which are organic, improves soil drainage and water retention, are full of nitrogen to promote growth and promotes earthworms, which further improve soil quality.

In one embodiment, protective plant barrier and soil enhancer 100 may include:

| Ingredients by gram | Ranges by percent weight |
|---|---|
| Portland cement - 844 grams | PC - 50-60% |
| Diatomaceous earth - 112 grams | DE - 5-15% |
| Peat moss - 128 grams | PM - 5-15% |
| Vermiculite - 100 grams | VC - 5-15% |
| Earthworm castings - 116 grams | EC - 7.5-20% |
| Black pepper - 70 grams | BP - 2.5-7.5% |
| Coffee grounds - approximately 70-75 grams | CG 2.5-7.5% |
| Bone Meal - 72 grams | BM - 2.25-7.5% |

Additional examples of ingredients that could be used are as follows: cayenne pepper, hot pepper extracts, blood meal, Epsom salt, allium extracts, rosemary extracts or oils, tansy extract, neem oil, peppermint oil, and vinegar tea and worm tea.

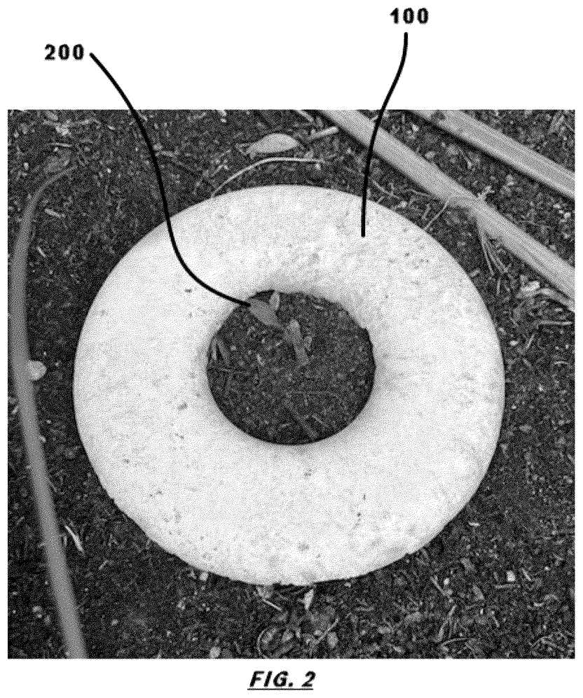

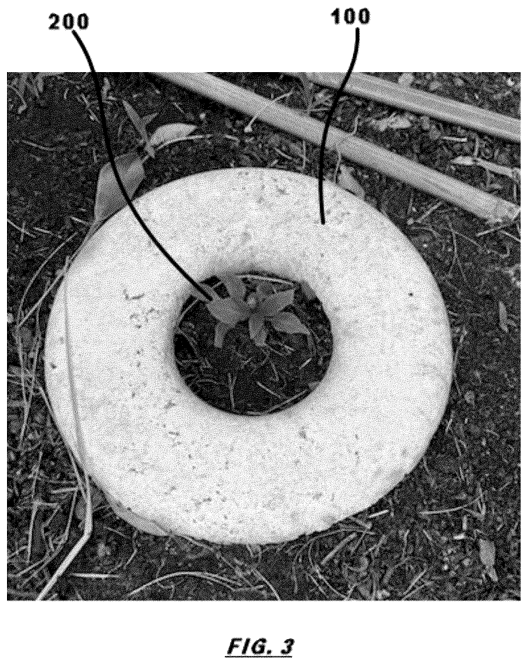

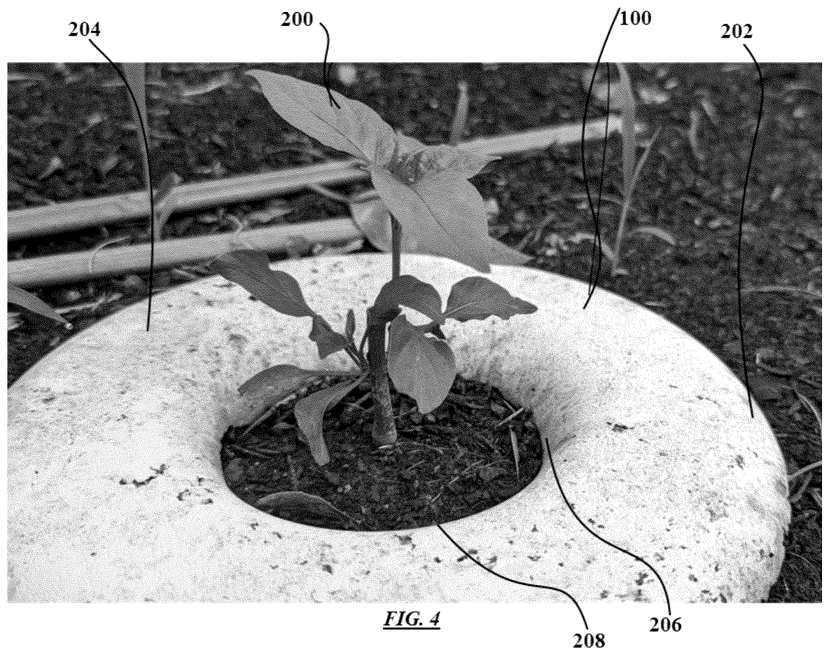

FIG. 2 shows a seedling 200 at 4 weeks growth, growing in protective plant barrier and soil enhancer 100. FIG. 3 shows seedling 200 at 5 weeks growth, growing in protective plant barrier and soil enhancer 100. FIG. 4 shows seedling 200 at 6 weeks growth, growing in in protective plant barrier and soil enhancer 100.

In one embodiment, applicant dubs its device HALO. HALO is a multifaceted pest defense and plant support system, with a focus on natural, nontoxic, and organic ingredients. Most of the ingredients kill or deter the majority of garden pests, as well as supporting the plant's overall health. Each HALO, as the name implies, is a circular ring that surrounds the plant at the ground level. This placement serves a few purposes; it anchors the plant and offers its roots an added layer of protection. It also allows the ingredients to come into direct contact with the soil, allowing them to better impart their health benefits to the surrounding plants. Finally, many insects will be stopped at the ground level before they can impact the plant. Sloping wall 202, see FIG. 4, of the ring are difficult for many pests to traverse, the rough surface disrupts their ability to use adhesion to climb, and the primary ingredients, Diatomaceous earth, vermiculite and peat moss, cuts and pierces their exoskeleton and wicks moisture from their bodies rapidly. For instance, sloping wall 202 may be sloped at an angle. This may include obtuse, right, and acute angles ranging from approximately 0 to 180 degrees, including subranges such as 10 to 170, 20 to 160, 30 to 150, 40 to 140, 50 to 130, 60 to 120, 70 to 110, 80 to 100, as well as subranges and particular specific angles contained within these ranges such as for purposes of example and not intended to be limiting, from 10 to 90 degrees, 20 to 80, 35 to 75, 45 to 65, etc. Indeed, in some embodiments, sloping wall 202 may form a single continuous slopped wall formed as an outer surface of enhancer 100. Still further, there may be an interior sloping wall 206 defined by enhancer opening 104 with the same or different slope than sloping wall 202. Interior sloping wall 206 may also be formed as a single continuous sloped wall forming enhancer interior 208. In one embodiment, sloping wall 202 and interior sloping wall 206 may be formed parallel to one another. Further, sloping wall 202 and interior sloping wall 206 may be formed as larger and smaller concentric rings having the same slope, see FIG. 4. Even further, sloping wall 202 and interior sloping wall 206 may have the same or different slopes relative to one another.

HALO products begin to lose some efficacy after approximately 12 weeks. This can fluctuate based on an area's climate and weather patterns. It is most affected by moisture. The primary ingredient is embedded into the entire surface of the HALO and can be washed away over time. However, the rest of the ingredients, which are infused throughout the body of the ring, can remain effective past the 12-week mark. Ultimately, as of now, these rings can be used indefinitely, but we highly recommend replacing the product at approximately 12 weeks.

To make a HALO, first, one will assemble and pre-measure all ingredients. Next, the primary ingredients (DE, vermiculite and peat moss) will be mixed with water thoroughly. As one adds in the remaining ingredients, one may need to adjust the water ratio. The next step, adding a binder, is optional, but will make the product more structurally sound. Next, use a mold to fill and form the rings. Allow these to cure for approximately 24-72 hours depending on size. Demold the pieces. Finally, place in a desired area of a garden, plant bed, nursery, etc., and get growing.

Various modifications and variations of the described methods, compositions, and kits of the disclosure will be apparent to those skilled in the art without departing from the scope and spirit of the disclosure. Although the disclosure has been described in connection with specific embodiments, it will be understood that it is capable of further modifications and that the disclosure as claimed should not be unduly limited to such specific embodiments. Indeed, various modifications of the described modes for carrying out the disclosure that are obvious to those skilled in the art are intended to be within the scope of the disclosure. This application is intended to cover any variations, uses, or adaptations of the disclosure following, in general, the principles of the disclosure and including such departures from the present disclosure come within known customary practice within the art to which the disclosure pertains and may be applied to the essential features herein before set forth.

What is claimed is:

1. A combination plant barrier and soil enhancer comprising:
a plant barrier comprising a shaped enhancer body;
wherein the shaped enhancer body defines at least one shaped internal opening;
wherein the shaped enhancer body contains at least one insect repellent;
wherein the shaped enhancer body contains at least one soil conditioner;
wherein the shaped enhancer body defines at least one continuous sloped wall formed as an outer surface of the enhancer body; and
wherein the shaped enhancer body defines at least one continuous interior sloped wall formed as an inner surface of the enhancer body.

2. The combination plant barrier and soil enhancer of claim 1, further comprising wherein the shaped enhancer body is formed in a shape of a ring defining at least one shaped internal opening.

3. The combination plant barrier and soil enhancer of claim 1, further comprising wherein the at least one shaped internal opening is defined as a substantially circular opening.

4. The combination plant barrier and soil enhancer of claim 1, further comprising wherein the shaped enhancer body comprises a diameter of from 6 to 10 inches.

5. The combination plant barrier and soil enhancer of claim 1, further comprising wherein the shaped enhancer body comprises a width from 0.25 to 2.0 inches.

6. The combination plant barrier and soil enhancer of claim 1, further comprising wherein the shaped enhancer body comprises Portland cement, diatomaceous earth, peat moss, earthworm castings, black pepper, coffee grounds, and bone meal.

7. The combination plant barrier and soil enhancer of claim 6, further comprising the shaped enhancer body comprising Diatomaceous earth from 5 to 15 percent by weight, peat moss by 5 to 15 percent by weight, and vermiculite from 5 to 15% by weight.

8. The combination plant barrier and soil enhancer of claim 6, further comprising the shaped enhancer body comprising at least one pepper extract, blood meal, Epsom salt, at least one allium extract, at least one rosemary extract, tansy extract, neem oil, peppermint oil, vinegar tea and worm tea.

9. The combination plant barrier and soil enhancer of claim 1, further comprising wherein the shaped enhancer body defines at least one continuous interior sloped wall formed as an outer surface of the enhancer body.

10. The combination plant barrier and soil enhancer of claim 1, further comprising wherein the at least one continuous sloped wall and the at least one continuous inner wall defining different slopes with respect to one another.

11. A method for making a combination plant barrier and soil enhancer comprising:
forming a plant barrier comprising a shaped enhancer body;
configuring the shaped enhancer body to define at least one shaped internal opening;
configuring the shaped enhancer body to contain at least one insect repellent;
configuring the shaped enhancer body to contain at least one soil conditioner;
configuring the shaped enhancer body to define at least one continuous sloped wall formed as an outer surface of the enhancer body; and
wherein the shaped enhancer body defines at least one continuous interior sloped wall formed as an inner surface of the enhancer body.

12. The method for making a combination plant barrier and soil enhancer of claim 11, further comprising configuring the shaped enhancer body in a shape of a ring defining at least one shaped internal opening.

13. The method for making a combination plant barrier and soil enhancer of claim 11, further comprising configuring the at least one shaped internal opening as a substantially circular opening.

14. The method for making a combination plant barrier and soil enhancer of claim 11, further comprising configuring the shaped enhancer body with a diameter of from 6 to 10 inches.

15. The method for making a combination plant barrier and soil enhancer of claim 11, further comprising configuring the shaped enhancer body with a width from 0.25 to 2.0 inches.

16. The method for making a combination plant barrier and soil enhancer of claim 11, further comprising configuring the shaped enhancer body to comprise Portland cement, diatomaceous earth, peat moss, earthworm castings, black pepper, coffee grounds, and bone meal.

17. The method for making a combination plant barrier and soil enhancer of claim 16, further comprising configuring the shaped enhancer body to comprise Diatomaceous earth from 5 to 15 percent by weight, peat moss by 5 to 15 percent by weight, and vermiculite from 5 to 15% by weight.

18. The method for making a combination plant barrier and soil enhancer of claim 11, further comprising configuring the shaped enhancer body to comprise at least one pepper extract, blood meal, Epsom salt, at least one allium extract, at least one rosemary extract, tansy extract, neem oil, peppermint oil, vinegar tea and worm tea.

19. The method for making a combination plant barrier and soil enhancer of claim 11, further comprising configuring the shaped enhancer body to define at least one continuous interior sloped wall formed as an outer surface of the enhancer body.

20. The method for making a combination plant barrier and soil enhancer of claim 11, further comprising configuring the at least one continuous sloped wall and the at least one continuous inner wall to define different slopes with respect to one another.
